(19) United States
(12) Patent Application Publication
(10) Pub. No.: US 2008/0011974 A1
(43) Pub. Date: Jan. 17, 2008

(54) MULTIPOSITION ANGLE VALVE

(75) Inventor: Arthur J. BRENES, Castro Valley, CA (US)

Correspondence Address: MORGAN, LEWIS & BOCKIUS, LLP, ONE MARKET SPEAR STREET TOWER, SAN FRANCISCO, CA, 94105, US

(73) Assignee: HIGH VACUUM APPARATUS, MFG., INC., Reno, NV (US)

(21) Appl. No.: 11/775,203

(22) Filed: Jul. 9, 2007

Related U.S. Application Data
(60) Provisional application No. 60/819,830, filed on Jul. 10, 2006.

(51) Int. Cl. F16K 1/00

(52) U.S. Cl. 251/333

(57) ABSTRACT

An angle valve including a valve housing defining a valve chamber and having a valve opening, a driveshaft reciprocally extending into the valve chamber through a driveshaft opening, a boss extending downwardly from a top wall of the valve chamber around the driveshaft, and a bellows having a lower end mounted to the boss and an upper end mounted to the driveshaft so as to isolate the driveshaft and the driveshaft opening from the valve chamber. A method of using the gate valve is also disclosed.

### CROSS-REFERENCE TO RELATED APPLICATIONS

This application claims the benefit of under 35 U.S.C. §119(e) to U.S. Ser. No. 60/819,830, filed Jul. 10, 2006, incorporated herein by reference in its entirety.

### BACKGROUND OF THE INVENTION

1. Field of the Invention

This invention relates, in general, to angle valves and more particularly to valves with adjustable opening positions and methods for their use.

2. Description of Related Art

The angle valve of the present invention is directed to use with cluster platforms. In the semiconductor industry, substrate handling systems referred to as cluster assemblies move substrates into and out of process modules. Various processes are performed on the substrate unit in each process module. An example of such a cluster platform is the Marathon Series cluster platform manufactured and sold by Brooks Automation of Lowell, Mass.

The sensitive nature of the fabrication materials and processes typically requires minimization of contaminants. Generally, the process modules operate on the substrates in a “clean room” atmosphere under vacuum. Angle valves connect vacuum pumps and similar components to the process modules to seal the modules and likewise gas down or evacuate the modules. While such valves have two positions, open and closed, it is would be advantageous to provide such valves with a third position in which the valve slightly opens to initially open and expose the valve to the vacuum within process chamber.

Similar to the process modules, present angle valves have been designed to limit the generation and introduction of contaminants within the cluster assembly and process modules. In order to limit the introduction of contaminants to the assembly system, angle valves typically isolate moving parts from the process modules. Bellows are a common means for isolating moving parts within the valve. Presently, when bellows are used in angle valves, the valve is configured such that the vacuum is on the outside of the bellows. While such configuration has proven adequate, such configuration often requires replacement of the bellows every 300,000 cycles.

Modern semiconductor manufacturing subjects process modules and angle valves to thousands of cycles of operation each month. In addition, many assembly plants run at or near capacity to maximize efficiency and minimize costly downtime. Therefore, all the components connected to the cluster assemblies desirably limit the frequency of repair and replacement, which contribute to downtime.

What is needed is an angle valve which overcomes the above and other disadvantages of known angle valves.

### BRIEF SUMMARY OF THE INVENTION

In summary, one aspect of the present invention is directed to an angle valve including a valve housing defining a valve chamber and having a valve opening, a driveshaft reciprocally extending into the valve chamber through a driveshaft opening, a boss extending downwardly from a top wall of the valve chamber around the driveshaft, and a bellows having a lower end mounted to the boss and an upper end mounted to the driveshaft so as to isolate the driveshaft and the driveshaft opening from the valve chamber.

According to another aspect of the invention, the boss may be substantially cylindrical and includes a flange at a lower end thereof. The angle valve may further include a valve plate mounted to a lower end of the driveshaft dimensioned and configured to seal the valve opening.

In one embodiment, the angle valve may further include a piston chamber adjacent to the valve chamber. The piston chamber and valve chamber may be operably connected by the driveshaft opening. An upper end of the driveshaft may be secured by a drive piston slidably secured within the piston chamber. A central portion of the driveshaft may be slidably secured by the driveshaft opening in the valve chamber.

In one embodiment, the valve housing may further include an exhaust port. The valve opening may be a chamber port connected to a process chamber and the exhaust port may be connected to a pump. The exhaust port may be substantially perpendicular to the chamber port.

In another embodiment, the driveshaft may be reciprocable between an open position, a closed position, and a partial-open position. An interior of the bellows may be under vacuum and an exterior may be at ambient pressure. The bellows may be affixed at an upper end thereof to the driveshaft and a lower end to the mounting body. The bellows may be stainless steel.

In one embodiment, the angle valve includes a piston stop assembly. The stop assembly may be configured to limit the upward movement of an upper end of the driveshaft in the piston chamber. The stop assembly may oppose the driveshaft in the piston chamber and may be configured to be adjustably set at a fixed height within the piston chamber.

The stop assembly may include a support rod extending into the piston chamber, a stop piston carried on a lower end of the support rod and housed in the piston chamber and independent of the drive piston, and a knob adjustably secured to the support rod along a portion thereof outside of the piston chamber. The knob may be configured for adjustably limiting the downward movement of the stop assembly. The knob may be threaded to the support rod.

In one embodiment, the angle valve includes a first pressure source configured for applying downward first pressure to the drive piston to move the driveshaft to a closed position. A second pressure source may be configured for applying downward second pressure to the stop piston to move the stop piston to a stop position. A third pressure source may be configured for applying an upward third pressure to the drive piston to move the drive piston upwardly. The angle valve may be in a partial-open position when there may be a positive pressure differential in which the second pressure exceeds a third pressure thereby causing the drive piston to abut against the stop piston in the stop position. The partial-open position may be defined by a pressure differential between the stop assembly and valve driveshaft such that the stop assembly may be in a lowered position and abutting the piston plug.

In one embodiment, the method of using the angle valve includes the steps of providing an angle valve configured to gas-down a process chamber, the angle valve including a valve chamber, a driveshaft reciprocally extending into the valve chamber and carrying a valve plate for selectively closing a chamber opening, and a piston chamber for reciprocally driving the driveshaft, applying a first pressure to the piston chamber moving the driveshaft and valve plate to a closed position, applying a second pressure to the piston chamber moving a stop piston to a stop position, and applying a third pressure to the piston chamber, moving the drive piston upwardly towards the stop piston thereby moving the valve plate upwardly from a closed position. The second pressure may exceed the third pressure causing the drive piston to abut against the stop piston in the stop position thereby positioning the valve plate in a partial-open position.

In one embodiment, the step of moving the valve plate from a partial-open position to a full-open position may be performed by removing the first and second pressures. The step of moving the valve plate from a partial-open position to a full-open position may be performed by increasing the third pressure to exceed both of the first and second pressures.

In one embodiment, the method includes the step of providing a bellows for isolating the driveshaft from the valve chamber. The bellows may be mounted to a boss extending downwardly from an upper wall of the valve chamber and an interior of the bellows may be exposed to the valve chamber.

The angle valve of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is an isometric view of an angle valve in accordance with the present invention.

FIG. 2 is a side, cross-sectional view of the angle valve of FIG. 1 along the line A-A, the angle valve shown in a closed position.

FIG. 3 is a side, cross-sectional view of the angle valve of FIG. 1, similar to FIG. 2 except for the angle valve being shown in a partial-open position.

FIG. 4 is a side, cross-sectional view of the angle valve of FIG. 1, similar to FIG. 2 except for the angle valve being shown in an open position.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

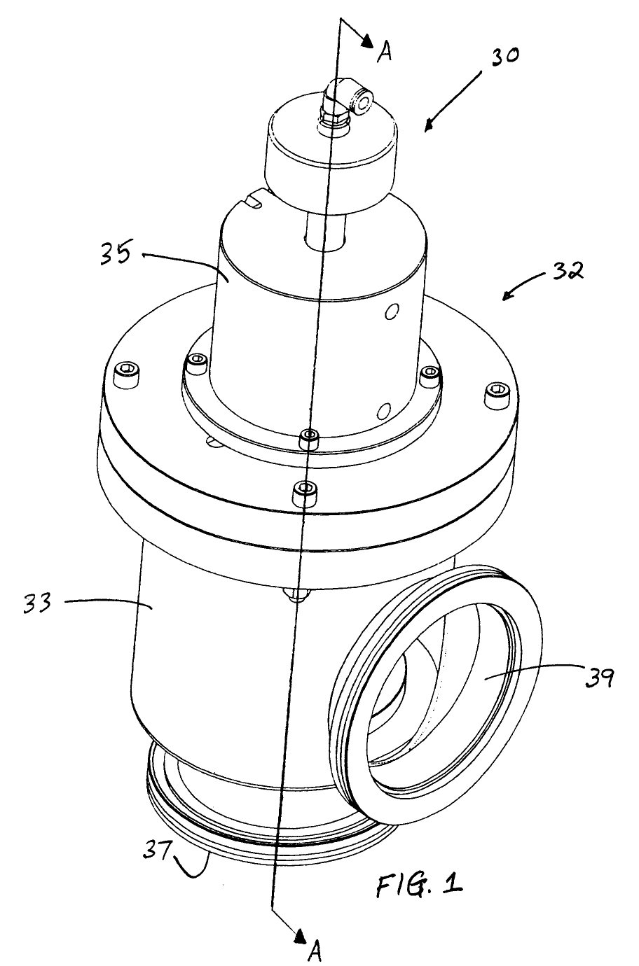

Turning now to the drawings, wherein like components are designated by like reference numerals throughout the various figures, attention is directed to FIG. 1 which shows an isometric view of an angle valve, generally designated 30.

Referring to FIG. 1, angle valve 30 includes a valve housing, generally designated 32. Housing 32 includes a main housing 33 and an upper housing 35. In the illustrated embodiment, a bottom wall of the main housing includes a chamber port 37 therethrough. An exhaust port 39 substantially perpendicular to the chamber port extends through a side wall of the main housing.

In the illustrated embodiment, the housing is assembled from multiple components. One will appreciate, however, that the housing construction may vary including, but not limited to, a unitary construction or multiple subassemblies.

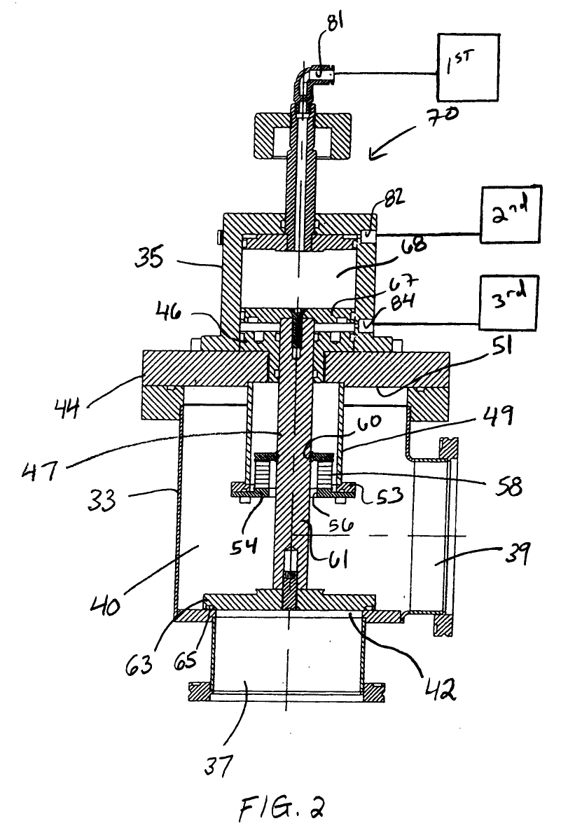

Turning to FIG. 2, the interior of main housing 33 defines a valve chamber 40. A valve opening 42 lies at a bottom of the valve chamber. An upper or top end 44 of the valve chamber includes a driveshaft opening 46. A driveshaft 47 extends through the driveshaft opening and reciprocates in the valve chamber. Known fasteners including, but not limited to, lubricated sealing rings or bearings slidably secure a central portion of the driveshaft in the driveshaft opening.

In one embodiment, a boss 49 extends downwardly from a top wall 51 of valve chamber 40. In the illustrated embodiment, the boss is substantially cylindrical and extends around the driveshaft in the valve chamber. One will appreciate that the boss may have other shapes, however, a cylindrical shape is particularly suited for accommodating and receiving a cylindrical bellows. A lower end of the boss includes a flange section 53. The flange section defines a plane perpendicular to an inner surface of the boss. A mounting body 54 extends inwardly of the boss and mounts to the flange section with an otherwise conventional fastener. For example, stainless steel threaded fasteners maybe utilized to removably secure the flange mounting body to the flange section.

The driveshaft opening slidably secures an upper portion of the driveshaft as it reciprocates. The mounting body includes a boss opening 56 therethrough configured to receive the driveshaft below the driveshaft opening. A sealing ring, bearing, or other movable sealing member seals boss opening 56 to a central portion of the driveshaft below the driveshaft opening. In this configuration, the driveshaft will be allowed to reciprocate in a longitudinal direction but will be secured in a lateral direction perpendicular to an axis of the driveshafit.

In one embodiment, a bellows 58 is provided to isolate the driveshaft and the driveshaft opening from the valve chamber. In the illustrated embodiment, the bellows mounts at a lower end to mounting body 54. An interior wall of the bellows is thus exposed to the valve chamber through boss opening 56 in the mounting body. An upper end of the bellows mounts to the driveshaft at a mounting point 60. Suitable material for the bellows includes, but is not limited to, stainless steel, aluminum, and other metals, composites, or the like.

In contrast to the existing art, the bellows of the present invention extends from a lower end of the boss to mounting point 60. As the driveshaft reciprocates, an upper end of the bellows extends from a point adjacent to flange section 53 to a point adjacent to driveshaft opening 46.

One will appreciate that other configurations may be employed for isolating the driveshaft including, but not limited to, use of more than one bellows or other isolating members. Although the bellows are mounted to a mounting body in the illustrated embodiment, one will also appreciate that other mounting configurations may be used to mount the bellows.

One will also appreciate that the length of the boss and subsequent length of the bellows may be shorter or longer than the illustrated embodiment. For example, the boss may extend to and secure a lower portion of the driveshaft near the valve opening thus increasing the stability of the reciprocating driveshaft. Alternatively, the length of the boss may be reduced so as to minimize the use of materials or shorten the profile of the angle valve.

The driveshaft includes a driveshaft rod 61 with a valve plate 63 mounted at a lower end. In the illustrated embodiment, the valve plate is slightly larger than the valve opening and includes a sealing ring 65 to form a tight seal in a closed position; however one will appreciate that other sealing configurations may be employed.

An upper end of the driveshaft includes a plug or drive piston 67 slidably secured within a piston chamber 68. The drive piston is configured to reciprocate in the piston chamber. The drive piston also serves to secure a top end of the driveshaft in a lateral direction. In the illustrated embodiment, upper housing 35 mounts to top wall 51 of the valve chamber and thereby defines the piston chamber. The piston chamber thus lies adjacent to and above the valve chamber. Driveshaft opening 46 extends between the piston chamber and valve chamber such that the two chambers are operably connected by the opening and driveshaft reciprocating therethrough.

One will appreciate that the piston chamber may be located in other positions relative to the valve chamber and include alternative configurations. For example, the piston chamber may be located remotely from the valve chamber and the driveshaft rod may be lengthened to traverse the additional distance.

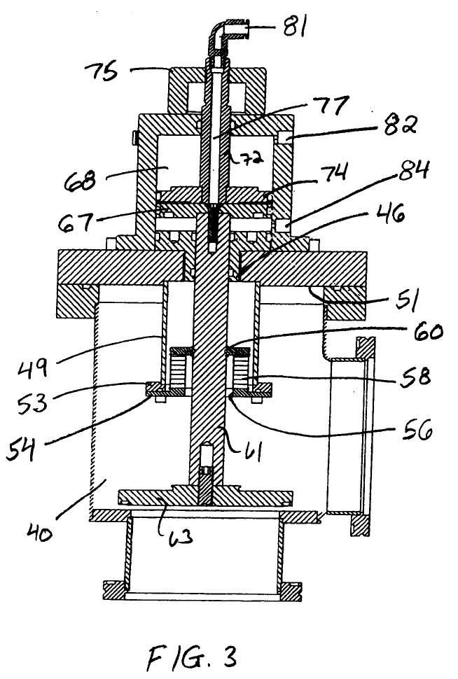

In the illustrated embodiment, angle valve 30 includes a piston stop assembly 70 configured to limit the upward movement of an upper end of the driveshaft in the piston chamber. The stop assembly serves to set a partial-open position of valve plate 63 carried on the lower end of the driveshaft, as shown in FIG. 3. In the partial-open position, the seal between the valve plate and valve opening is partially open exposing chamber port 37 but the flow to the process chamber below valve 30 is still partially restricted by the valve plate. In the illustrated embodiment, the stop assembly opposes the driveshaft in the piston chamber such that the upward movement of an upper end of the driveshaft in the piston chamber may be limited.

In this embodiment, the stop assembly includes a support rod 72 extending into the piston chamber, a stop piston 74 carried on a lower end of the support rod, and an adjusting knob 75. The stop piston is housed in the piston chamber and moves independently of the drive piston. In the illustrated embodiment, the knob is adjustably secured to the support rod with a threaded screw-and-nut configuration along a portion of the rod extending outside of the piston chamber. In this manner, the knob may be rotated to a set an axial position on the piston rod. The knob may be adjustably secured to the rod with alternative configurations including, but not limited to, a ratchet configuration, set screws, detent assemblies or the like.

As support rod 72 moves downward, knob 75 limits the downward movement of the stop assembly thus setting a fixed height of stop piston 74 within the piston chamber. In the lowered position with the knob abutting the top of the valve chamber, stop piston 74 opposes and limits the drive path of drive piston 67 (best seen in FIG. 3). Thus the upward movement or maximum height of drive piston 67 in piston chamber 68 will be limited and an intermediate, partial-open position will be determined.

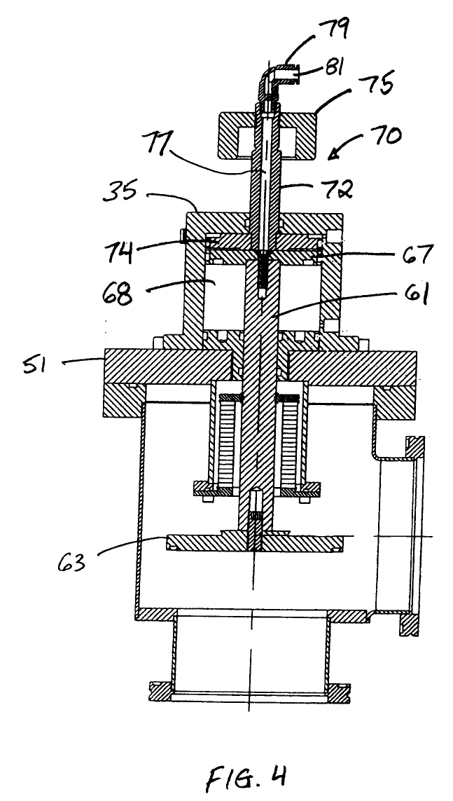

In contrast to the partial-open position, in an open position the driveshaft is fully extended or driven upward to an upper position to allow maximum flow to the valve opening, as shown in FIG. 4. In the open position the driveshaft is merely limited by the top of the piston chamber. The driveshaft may also be limited in the open position by the lower end of the boss, a stop member, or other limiting means.

In the closed position, the driveshaft lies in a lower position and valve plate 63 seals to valve opening 42, as shown in FIG. 2. Downward pressure on the driveshaft maintains a seal between the valve plate and valve opening. One will appreciate that other configurations may be employed to adjustably limit or control the movement of the driveshaft between the open and closed positions including, but not limited to, stop members located on the interior walls of the piston chamber and the like.

The method of using an angle valve in accordance with the present invention can now be described. Angle valves are commonly used to gas down or evacuate process chambers in semiconductor manufacturing. The angle valve may also be used to control the introduction of gas fluids to the process modules for cleaning or processing. Such angle valves are connected to a port from the process chamber at one end and to an exhaust pump or similar component at another end. Following preparation of the process chamber for processing, the angle valve opens to the process chamber and allows the process chamber to be evacuated. Similarly, users may periodically choose to relieve some of the pressure in the process chamber or apply a minimal positive pressure to the process chamber.

In the illustrated embodiment, angle valve 30 is actuated with pneumatics; however, one will appreciate that other actuation means may be employed including, but not limited to, solenoids, hydraulics, and the like.

Piston stop assembly 70 includes a conduit 77 with a stem 79. A first inlet 81 at an end of the stem connects to a first pressure source. The first pressure source feeds a downward first pressure through the conduit to piston chamber 68 above drive piston 67. The downward pressure forces the driveshaft to move to the closed position. Application of the first pressure also drives the piston stop and drive piston apart such that the piston stop moves upward (best seen in FIG. 2).

The angle valve includes a second pressure source and third pressure source. The second pressure source applies fluid pressure to a second inlet 82 in the piston chamber. The second pressure source and inlet are configured to apply a downward second pressure above the stop piston to move the stop piston downward to a stop position set by knob 75. The third pressure source applies a third pressure to a third inlet 84. The third pressure applies an upward pressure to the bottom of drive piston 67 such that the drive piston and driveshaft are driven upwards.

As discussed, the stop piston opposes the drive piston such that the two contact each other when both the second pressure and third pressure are applied to the angle valve. In one embodiment, this contact of the stop piston with the drive piston controls the partial-open position. In the illustrated embodiment, the second pressure is 70 pounds per square inch (psi) and the third pressure is in the range of 30 to 50 psi. This positive pressure differential between the second and third pressure sets the stop piston in the lowered stop position and further forces the drive piston to abut the stop piston. The third pressure will retain the driveshaft against the piston stop in the partial-open position but will be insufficient to move the stop piston from the partial-open position.

As best seen in FIG. 3, in the partial-open position the driveshaft and valve plate are raised from the valve opening but limited by the stop piston. In the partial-open position, the process chamber may be partially exposed to an ambient environment, vacuum pump, or the like to control the process chamber pressure as desired.

In operation and use, the first pressure source applies a downward first pressure to the piston chamber moving the driveshaft and valve plate to a closed position. Thereafter, when a user chooses to gas down or adjust the pressure in the process chamber, the second pressure source applies a second pressure to move the stop piston to the stop position and the third pressure sources applies a third pressure to move the drive piston upwardly towards the stop piston. The driveshaft and valve plate will thus be moved from the closed position to the partial-open position.

Between cycles, the user can fully evacuate the process chamber by selecting an open position. To reach the open position, the second pressure will be relieved or removed such that the pressure differential will be eliminated. The first pressure is further removed to allow the driveshaft to move upwards. In another embodiment, a negative pressure differential can be set such that the third pressure exceeds and overcomes the first and second pressures. The drive piston will thus abut the stop piston and drive the whole stop assembly upwards. Although the methods of controlling and setting the positions of the angle valve have been described, one will appreciate that other pneumatic methods and configurations may be employed to move the valve from the closed to the partial-open and open positions.

In operation, angle valve 30 maintains a positive pressure environment of a process module to which it connects. As discussed, bellows 58 seals driveshaft 47 so as to isolate contaminants generated from the friction of the driveshaft reciprocating in driveshaft opening 46. In one embodiment, an interior of the bellows is exposed to the valve chamber through boss opening 56 and is thus under vacuum. An exterior of the bellows is outside of the valve chamber environment and thus does not need to be maintained at clean room levels nor under vacuum but instead may be at ambient pressure.

In the existing art, bellows are mounted to a top end of the valve chamber and to the valve plate at a lower end. Thus, with existing bellows mounting positions the bellows are exposed to the inverse environment of the present invention with an exterior under vacuum and interior at ambient pressure. It has been found that mounting bellows in accordance with the present invention allows the lifecycle of the bellows to be significantly extended ten-fold. For example, the configuration of the present invention has allowed a bellows to last in excess of 5.3 million cycles.

In addition to relieving stress on the bellows wall, the mounting configuration discussed also significantly reduces the extension length of the bellows, which reduces tensile and bending stresses in the bellows. In the illustrated embodiment, the full extension length of the bellows is less than or equal to the length of boss 49. In the existing art, the bellows can be extended to nearly the full height of the valve chamber.

For convenience in explanation and accurate definition in the appended claims, the terms “up” or “upper”, “down” or “lower”, “inside” and “outside” are used to describe features of the present invention with reference to the positions of such features as displayed in the figures.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. An angle valve comprising:
a valve housing defining a valve chamber and having a valve opening;
a driveshaft reciprocally extending into the valve chamber through a driveshaft opening;
a boss extending downwardly from a top wall of the valve chamber around the driveshaft; and
a bellows having a lower end mounted to the boss and an upper end mounted to the driveshaft so as to isolate the driveshaft and the driveshaft opening from the valve chamber.

2. An angle valve according to claim 1, wherein the boss includes a flange at a lower end thereof.

3. An angle valve according to claim 1, wherein the boss is substantially cylindrical.

4. An angle valve according to claim 1, further comprising a valve plate mounted to a lower end of the driveshaft dimensioned and configured to seal the valve opening.

5. An angle valve according to claim 1, further including a piston chamber adjacent to the valve chamber, the piston chamber and valve chamber being operably connected by the driveshaft opening.

6. An angle valve according to claim 5, wherein an upper end of the driveshaft is secured by a drive piston slidably secured within the piston chamber, and a central portion of the driveshaft is slidably secured by the driveshaft opening in the valve chamber.

7. An angle valve according to claim 1, wherein the valve housing further includes an exhaust port, wherein the valve opening is a chamber port connected to a process chamber and the exhaust port connected to a pump, the exhaust port being substantially perpendicular to the chamber port.

8. An angle valve according to claim 1, wherein the driveshaft is reciprocable between an open position, a closed position, and a partial-open position.

9. An angle valve according to claim 1, wherein an interior of the bellows is under vacuum and an exterior is at ambient pressure.

10. An angle valve according to claim 1, wherein the bellows is affixed at an upper end thereof to the driveshaft and a lower end to the mounting body.

11. An angle valve according to claim 1, wherein the bellows is stainless steel.

12. An angle valve according to claim 5, further comprising a piston stop assembly, wherein the stop assembly is configured to limit the upward movement of an upper end of the driveshaft in the piston chamber.

13. An angle valve according to claim 12, wherein the stop assembly opposes the driveshaft in the piston chamber, the stop assembly configured to be adjustably set at a fixed height within the piston chamber.

14. An angle valve according to claim 12, wherein the stop assembly includes:
a support rod extending into the piston chamber;
a stop piston carried on a lower end of the support rod, the stop piston being housed in the piston chamber and independent of the drive piston; and
a knob adjustably secured to the support rod along a portion thereof outside the piston chamber, wherein the knob is configured for adjustably limiting the downward movement of the stop assembly.

15. An angle valve according to claim 14, wherein the knob is threaded to the support rod.

16. An angle valve according to claim 14, further including a first pressure source configured for applying downward first pressure to the drive piston to move the driveshaft to a closed position.

17. An angle valve according to claim 16, further including a second pressure source configured for applying downward second pressure to the stop piston to move the stop piston to a stop position, and a third pressure source configured for applying upward third pressure to the drive piston to move the drive piston upwardly.

18. An angle valve according to claim 1, wherein the angle valve is in a partial-open position when there is a positive pressure differential in which the second pressure exceeds a third pressure thereby causing the drive piston to abut against the stop piston in the stop position.

19. An angle valve comprising:
a valve housing defining a valve chamber and having a valve opening to a process chamber at a lower end;
a piston chamber operably connected to the valve chamber;
a valve driveshaft, the valve driveshaft including a valve at a lower end configured to seal to the opening in the valve chamber and a piston plug at an upper end configured to reciprocate in the piston chamber;
a stop assembly housed within the piston chamber at a lower end, the lower end of the stop assembly opposing the piston plug; and
a partial-open position defined by a pressure differential between the stop assembly and valve driveshaft such that the stop assembly is in a lowered position and abutting the piston plug.

20. A method of using an angle valve comprising the steps of:
providing an angle valve configured to gas-down a process chamber, the angle valve including a valve chamber, a driveshaft reciprocally extending into the valve chamber and carrying a valve plate for selectively closing a chamber opening, and a piston chamber for reciprocally driving the driveshaft;
applying a first pressure to the piston chamber moving the driveshaft and valve plate to a closed position, applying a second pressure to the piston chamber moving a stop piston to a stop position; and
applying a third pressure to the piston chamber, moving the drive piston upwardly towards the stop piston thereby moving the valve plate upwardly from a closed position, wherein the second pressure exceeds the third pressure causing the drive piston to abut against the stop piston in the stop position thereby positioning the valve plate in a partial-open position.

21. The method of claim 20, further including the step of moving the valve plate from a partial-open position to a full-open position by removing the first and second pressures.

22. The method of claim 20, further including the step of moving the valve plate from a partial-open position to a full-open position by increasing the third pressure to exceed both of the first and second pressures.

23. The method of claim 20, further including the step of:
providing a bellows for isolating the driveshaft from the valve chamber, wherein the bellows is mounted to a boss extending downwardly from an upper wall of the valve chamber and an interior of the bellows is exposed to the valve chamber.
